(19) United States
(12) Patent Application Publication
(10) Pub. No.: US 2016/0074795 A1
(43) Pub. Date: Mar. 17, 2016

(54) FILTER ELEMENTS AND A FILTER DEVICE HAVING AT LEAST ONE FILTER ELEMENT

(71) Applicant: RAUSCHERT KLOSTER VEILSDORF GMBH, Veilsdorf (DE)

(72) Inventors: Volker PREHN, Kronach (DE); Manfred SCHAEFTLEIN, Eisfeld (DE)

(73) Assignee: Rauschert Kloster Veilsdorf GmbH, Veilsdorf (DE)

(21) Appl. No.: 14/784,616

(22) PCT Filed: Apr. 16, 2014
(86) PCT No.: PCT/DE2014/100134

§ 371 Date: Oct. 15, 2015

(30) Foreign Application Priority Data
Apr. 16, 2013 (DE) 10 2013 103 830.1

(51) Int. Cl. B01D 46/00; B01D 65/00; F16J 15/10; B01D 46/24; B01D 63/06

(52) U.S. Cl. CPC B01D 46/005; B01D 46/2455; B01D 46/0021; B01D 63/066; F16J 15/104; B01D 46/0001; B01D 65/003; B01D 2046/2492; B01D 2313/04

(57) ABSTRACT

The invention is directed to filter elements (1) made of a material which is permeable to permeate and which has a quantity of longitudinal channels (3) and a cross section that is a segment of a virtual rotationally symmetrical or mirror-symmetrical surface (4). The filter elements (1) can be joined to form a filter element composite (10). The filter elements (1) or the filter element composite (10) can be used in a filter device (11) for cleaning or separating a medium (7). Seals of the filter element composite (10) and/or filter device (11) can be formed by a potting layer (16), by individual seals (15) having a shape deviating from the shape of an O-ring, or by seal elements (17) with crosspieces (17.1) and apertures (17.2).

The invention is directed to filter elements and a filter device having at least one filter element as is known generically from DE 600 23 479 T2.

In addition to other types of filters, crossflow filters are also used for filtration particularly of particles from a particle-containing flow. In this type of filter, at least a fraction of the particle-containing flow passes through the channel walls of the filter transverse to the original flow direction.

A crossflow filter device configured to receive a feed stock at a feed end and to separate the feed stock into filtrate and retentate is known from the above-cited DE 600 23 479 T2. The filtrate is that fraction of the feed stock that has passed through at least one filter. The retentate is that fraction of the feed stock that is retained at the filter. A larger quantity of retentate can result in a filter cake, as it is called.

There are special requirements for filter devices, in this case for crossflow filter devices in particular, when the filter devices reach a determined (cross-sectional) size, e.g., several centimeters or even several tens of centimeters. With small cross-sectional sizes, a filtrate can exit a filter element within a certain period of time through diffusion and permeation. With large cross-sectional sizes, it is necessary to take technical steps to remove filtrate also from the interior of the filter element. Technical steps of this kind can consist, for example, in providing a filtrate conduit network such as is described in the above-cited DE 600 23 479 T2.

The crossflow filter device according to the above-cited DE 600 23 479 T2 comprises a plurality of monolith segments of porous material arranged parallel to one another. The monolith segments (hereinafter filter elements) are sealed by means of radial O-ring seals relative to a filter housing in which the crossflow filter device is accommodated and held. The filter elements have passageways (hereinafter channels) which are parallel in longitudinal direction and through which the feed stock to be cleaned can flow from the feed end in direction of a retentate end face. An intersegment filtrate conduit is provided between the filter elements. This can be provided by a space between the parallel filter elements. The intersegment filtrate conduit offers a lower flow resistance compared to passage through the porous material. At least one intrasegment filtrate conduit is provided inside each filter element. The intrasegment filtrate conduit communicates with the intersegment filtrate conduit or guides filtrate to a filtrate collecting zone in some other way. In a crossflow filter device according to the above-cited DE 600 23 479 T2, end faces are sealed in order to prevent filtrate from passing directly into the intersegment filtrate conduit. All of the open channels at the end faces are likewise sealed so as to prevent filtrate from passing directly into the intrasegment filtrate conduit. The filter elements can have a determined cross-sectional shape, for example, one fourth of the area of a circle. A crossflow filter device with a circular cross section can be provided, for example, by placing a plurality of filter elements together. The porous material of the filter elements can be a ceramic material such as cordierite, alumina, mullite, silica, zirconia, titania, spinel, silicon carbide, or mixtures thereof. The filter elements can also be glued together along portions of the intersegment filtrate conduit.

However, corresponding process steps in the production of a crossflow filter device according to the above-cited DE 600 23 479 T2 are required because of the required sealing of the end faces. Further, the construction of the crossflow filter device is correspondingly complicated and expensive.

It is the object of the invention to suggest a further possibility for constructing filter elements. It is a further object to provide a filter device, particularly a crossflow filter device, which can be produced efficiently and economically with variable dimensions and filter outputs.

The above-stated object is met through the subject matter of the independent patent claims. Advantageous embodiments are found in the dependent patent claims.

Therefore, the object is met through a filter element made of a material which is permeable to permeate and which has a quantity of longitudinal channels and a cross section that is a segment of a rotationally symmetrical or mirror-symmetrical surface.

When a corresponding quantity of filter elements according to the invention are placed together, the cross sections (segments) thereof together form rotationally symmetrical or mirror-symmetrical surfaces. In so doing, spaces are allowed between the segments and rounded edges and corners of the shape of the segments. Rotationally symmetrical surfaces are, in particular, circles and annuli. Mirror-symmetrical surfaces are surfaces with an axis of symmetry by which the surface is divided mirror-symmetrically. Mirror-symmetrical surfaces are, in particular, ellipses, rectangles or isosceles triangles.

Longitudinal channels (also referred to hereinafter for brevity as channels) are provided in the filter elements. The channels are preferably arranged parallel to one another. Openings can be provided in at least one outer surface of the filter element for guiding filtrate (permeate) out of the filter element. The terms “filtrate” and “permeate” are used synonymously in the following for fractions of a feed stock which have passed through a filter layer, e.g., a membrane or a channel wall. The channel wall can be formed as a membrane. The feed stock is usually a fluid, a gas or an aerosol in which particles are present which are to be separated from other parts of the feed stock. Particles within the meaning of the description can also be molecules. The particles must have a solid form or be solid bodies, and these bodies can also be individual molecules.

The filter elements and the device according to the invention are advantageous, but not exclusively suitable for filtration of molecule sizes of up to 450 g/mol and smaller and accordingly for nanofiltration.

The channels preferably have free diameters or inner widths between 2 and 3.5 mm. Free diameters (in case of round channel cross sections) or inner widths (in case of angular channel cross sections) of 2.5 mm are advantageous. In case of water or water-like feed stocks, the free diameters or inner widths are preferably around 2 mm or less. In case of more viscous and highly viscous feed stocks, the free diameters or inner widths are preferably greater than 4 mm to greater than 6 mm.

The filter elements can have a quantity of channels. For example, the quantity of channels per filter element can be between 10 and 180 or more, e.g., 19 or 163.

The channels can perform different functions. Accordingly, some channels (longitudinal channels) can serve mainly for filtration, while other channels serve to guide off filtrate or permeate (permeate outlets, discharge channels). Channels with various functions can be provided in the filter elements according to the invention in determined ratios and/or in determined spatial arrangements with respect to one another.

The channel walls are preferably greater than or equal to 1 mm. They should withstand a pressure of up to 10 bar, better yet up to 20 bar, advantageously up to 40 bar. A typical pressure range for nanofiltration is around 10 bar to 40 bar; higher pressures are also possible depending on the material used.

The length of a filter element and, therefore, also the length of a channel, is 750 mm, for example. Lengths of 1000, 1178, 1200 and 1500 mm are also common. Other lengths are conceivable and can be realized depending on the modular concept.

Advantageous material for the filter elements is a material having a porosity of about 30% and average pore sizes of 2 to 12 μm. The material can be mullite, for example. Other possible materials further include aluminum oxide (Al₂O₃), other oxide ceramics, mullite, other silicate ceramics, cordierite, silicon carbide (SiC), titania (TiO₂), zirconia (ZrO₂), or other non-oxide ceramics such as mixed ceramics from the above-mentioned compounds.

In a filter element according to the invention, there are provided between the longitudinal channels, at least along a longitudinal portion of the filter element, material zones which extend from an outer wall of the filter element some distance into the filter element, which are not penetrated by longitudinal channels and in which a slit is provided. No longitudinal channels are breached by the slit. In this embodiment, at least one permeate outlet is advantageously introduced, e.g., sawed, cut or milled, into the filter element without damaging the longitudinal channels. This advantageously obviates the need to re-close longitudinal channels which have been breached, i.e., cut into or severed. The material zones in which the slits can be introduced are preferably already produced during the production of the filter elements, for example, during extrusion thereof.

The filter elements according to the invention can be arranged in a filter element composite comprising a plurality of filter elements. A filter element composite of this type is characterized in that the cross sections of the filter elements are mutually complementing segments of a rotationally symmetrical surface or mirror-symmetrical surface, in that the filter elements are joined to one another while leaving a space between the filter elements as permeate outlets for conducting medium exiting from the filter elements as permeate, and in that the cross section of the filter element composite is the rotationally symmetrical surface or mirror-symmetrical surface.

The filter elements can be joined ceramically. Ceramic joining is preferably carried out by introducing a slurry in portions between the filter elements and sintering the filter elements and the slurry. A sintered disk is formed preferably in portions by means of the sintered slurry. The filter elements are enclosed on all sides over a longitudinal portion by the sintered disk. Sintered disks of this type are preferably provided at longitudinal portions at the ends of the filter elements, preferably in the center thereof with filter element lengths of about 500 mm. With filter element lengths greater than 500 mm in particular, further sintered disks can also be provided.

The slits are preferably introduced before sintering. It is also possible to introduce the slits after sintering.

A filter element composite according to the invention is also formed when the filter elements are arranged relative to one another in the manner described above by means of a mechanically acting device, for example, a holding frame. For example, a seal element can be formed as a holding frame of this kind.

The filter elements according to the invention enable the modular construction of a filter device, particularly a crossflow filter device for ceramic membrane filtration. Optimized filtration outputs can be achieved in this way. The possibility of modular construction from individual filter elements is advantageous. These filter elements can be joined, for example, ceramically or mechanically. The filter elements are not rotationally symmetrical in each instance. A rotationally symmetrical cross section of a filter device (entire membrane) only results with the arrangement of a quantity of correspondingly shaped filter elements. However, other cross sections of the filter elements are also possible, e.g., semicircular, angular, oval, elliptical or irregular. The filter elements are preferably arranged and held in a housing.

The cross sections of the filter elements can also be fourths, eighths, ninths, etc. of a circle (“pie slice”, segments). Further, the cross sections can have slits, e.g., slit semicircles.

It is further possible that a portion of the segments produces an annulus and a centrally arranged segment has a round cross section.

An arrangement of this type yields advantageous technical effects which lead to an enhanced filter performance. An optimized specific filter surface (filter surface/volume of the membrane=volume of the filter element) is achieved by means of the arrangement described herein. Further, an optimized filtrate discharge is provided through an implementation of special discharge channels and discharge spaces. Discharge channels of this type can be provided between filter elements which are arranged so as to be spaced apart.

The possibility of modular arrangement of the filter elements allows an optimization with respect to the hydraulic diameters of the channels for the filtration, the channels for removing the filtrate, the specific filter surface and/or a total filter surface.

The filter elements can preferably be provided with seals having an outer shape that is not round. The outer shape of the seals preferably corresponds to the outer shape of the filter elements or to the outer shape of a filter element in the region of the seat of the seal. The filter elements which are arranged to form a filter device are sealed relative to the housing of the filter device by the seals. Further, the seals can function as spacers of the filter elements relative to one another and/or relative to the housing. Discharge channels are advantageously formed between the filter elements in that the filter elements are spaced apart. Discharge channels can also be formed between at least one filter element and an inner wall of the housing.

An advantage of the filter elements according to the invention and a filter device according to the invention having these filter elements is that there is no need for additional ceramic sealing or other sealing of the discharge channels relative to the end of the filter elements at which the feed stock (medium) is supplied.

A construction of the filter device for cleaning a medium having filter elements according to the invention has a filter housing with an input opening for medium to flow into the filter housing and at least one output opening for the medium to flow out. Further, there are at least two filter elements with a quantity of longitudinal channels, the filter elements being arranged so as to extend from the input opening into the filter housing, and an end side of the filter elements stays open in each instance for medium to flow into the longitudinal channels of the filter elements. The filter elements are sealed by a seal at least at the input opening, and the filter elements are sealed relative to one another and relative to the filter housing and are kept at a distance from one another by the seal. Further, permeate outlets are formed by the spaces between the filter elements and relative to the filter housing for conducting medium exiting from the filter elements as permeate in direction of the at least one output opening.

The cross sections of the filter elements are preferably mutually complementing segments of a rotationally symmetrical surface or mirror-symmetrical surface.

The filter element composite described above can also be used in a filter device. A filter device of this type for cleaning a medium is preferably characterized in that a filter housing is provided which has an input opening for medium to flow into the filter housing and at least one output opening for the medium to flow out; the filter element composite is sealed by a seal at least at the input opening, and the filter elements of the filter element composite are sealed relative to one another and relative to the filter housing and are kept at a distance from one another by the seal, and permeate outlets are formed by the spaces between the filter elements and relative to the filter housing for conducting medium exiting from the filter elements as permeate in direction of the at least one output opening.

The filter device is preferably dimensioned in such a way that various filter elements or filter element composites can be inserted into the filter housing depending on requirements.

The filter devices can have a seal which is formed by a potting layer made of a sealing material.

In further embodiments, the seal can also be produced by at least one seal in the form of an individual seal, for example, in the form of a quarter circle-shaped rubber seal, for each filter element or by a seal element. The filter elements are then sealed relative to one another and relative to the filter housing at least at the input opening by a plurality of individual seals or by the seal element, and the filter elements are held at a distance from one another and at a distance from the filter housing by the individual seals or by the at least one seal element.

In uninstalled condition, an individual seal or a seal element of this type has the shape of the cross section of that filter element for which the seal element is provided. Since, as a rule, the filter elements do not have round cross sections, the individual seals or seal elements are likewise correspondingly shaped and deviate from the typical O-ring shape.

The individual seal and the seal element can be made from mixtures of a range of plastics, from a multicomponent plastic element or from a composite material. Further, they can have metal supporting elements or supporting elements of plastic, e.g., metal inserts or plastic inserts. In case of multicomponent plastic constructions, the various plastics preferably have different hardnesses and strengths.

In a further embodiment, the seal element is characterized in that the seal element is a disk-shaped element with crosspieces and apertures, and the shape and size of the apertures allow filter elements to be inserted into the apertures in a frictionally engaging manner. For example, the seal element can have a metal core which is enclosed by plastic. A sealing lip is formed along the inner sides of the apertures and along the outer circumference of the seal element by the outermost layer. A construction of this kind advantageously ensures that the seal element is highly stable and resistant to torsion, the filter elements being sealed relative to one another and held so as to be spaced apart from one another. A sealing relative to the filter housing can be achieved by means of the sealing lip along the outer circumference. A filter element composite according to the invention results when the filter elements are inserted into the sealing element.

The seal is formed by a potting layer particularly when the filter elements or filter element composite is never or rarely changed. If the filter elements or the filter element composite is to be changed or monitored more often, the seal is preferably achieved by means of a sealing element such as is described above.

Embodiment examples of the filter elements and filter devices with filter elements according to the invention are described in the following. The drawings show:

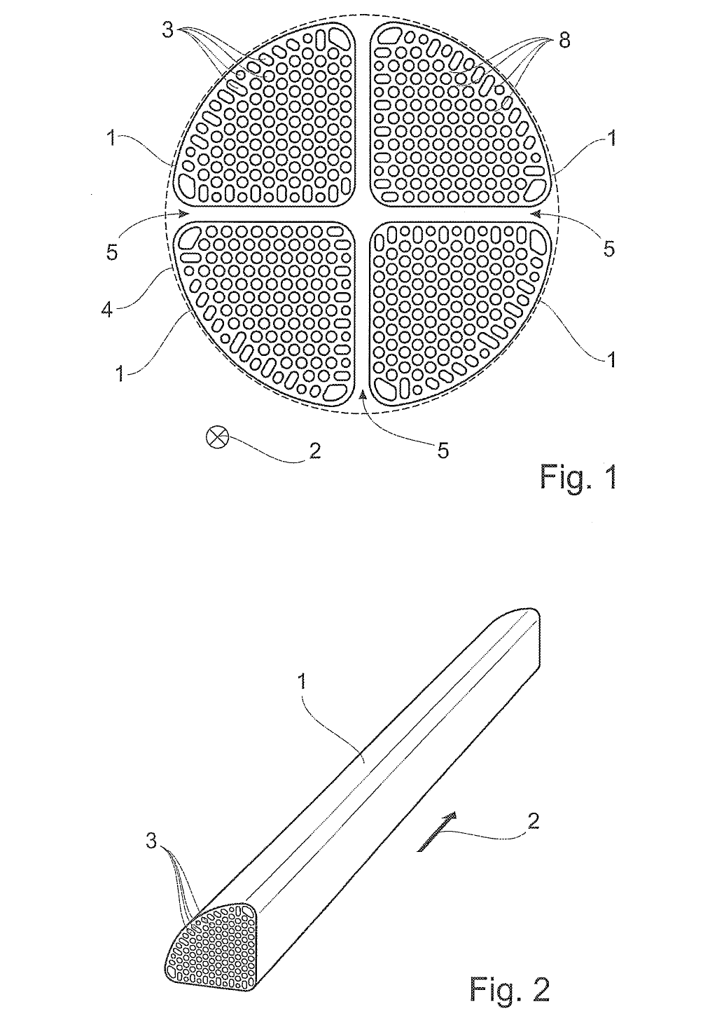

FIG. 1 cross sections of four filter elements according to the invention;

FIG. 2 a first embodiment example of a filter element according to the invention;

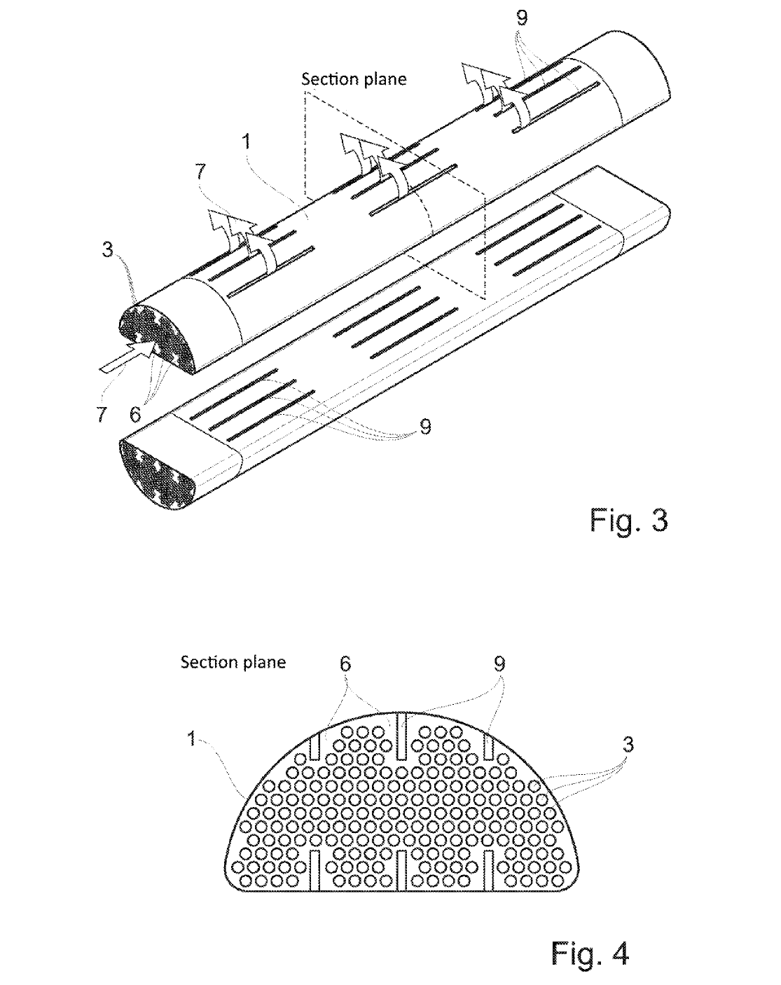

FIG. 3 a second embodiment example of a filter element according to the invention;

FIG. 4 an enlarged section of the second embodiment example of a filter element according to the invention in accordance with FIG. 3;

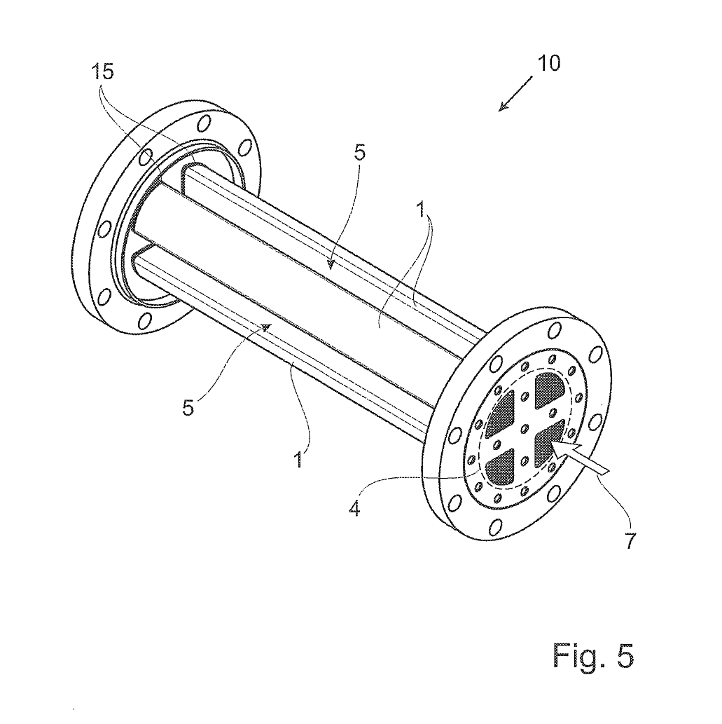

FIG. 5 a first embodiment example of a filter element composite;

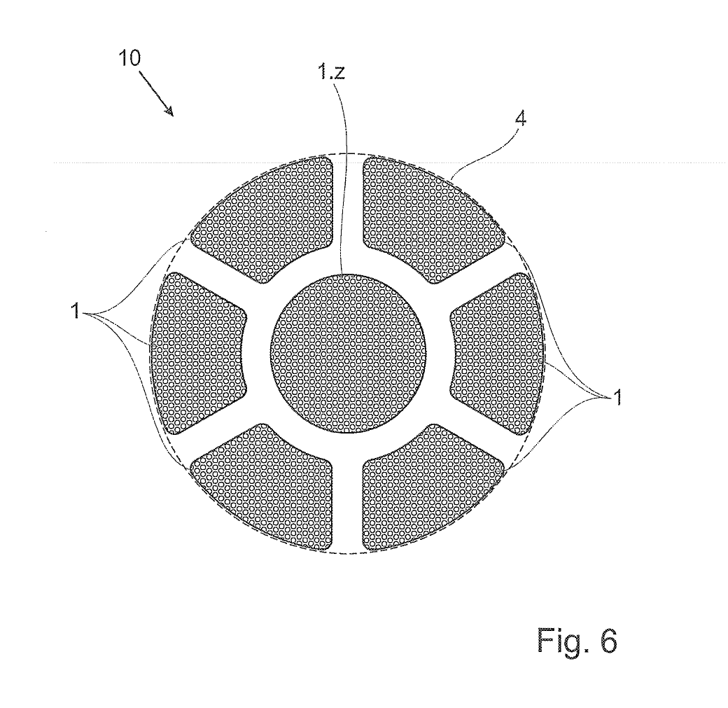

FIG. 6 a second embodiment example of a filter element composite;

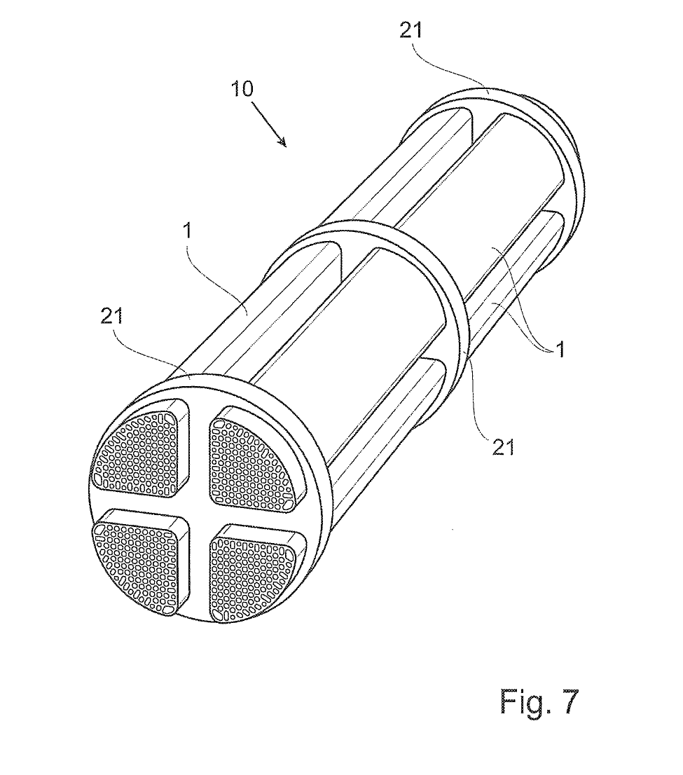

FIG. 7 a third embodiment example of a filter element composite;

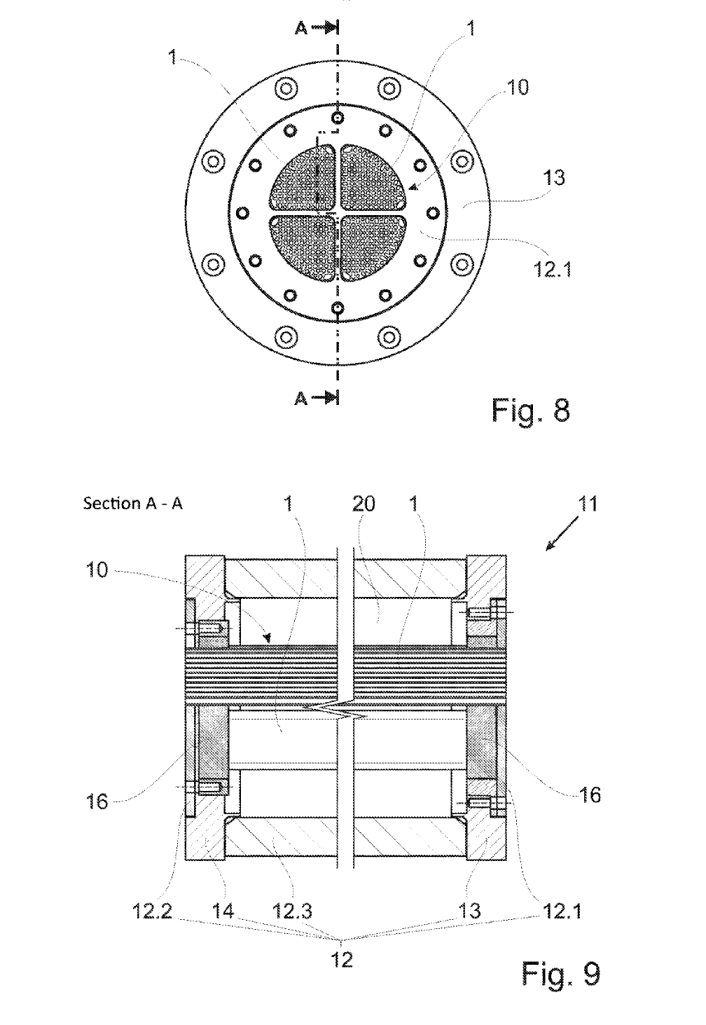

FIG. 8 a top view of a front side of a first embodiment example of a filter device;

FIG. 9 a first embodiment example of the filter device;

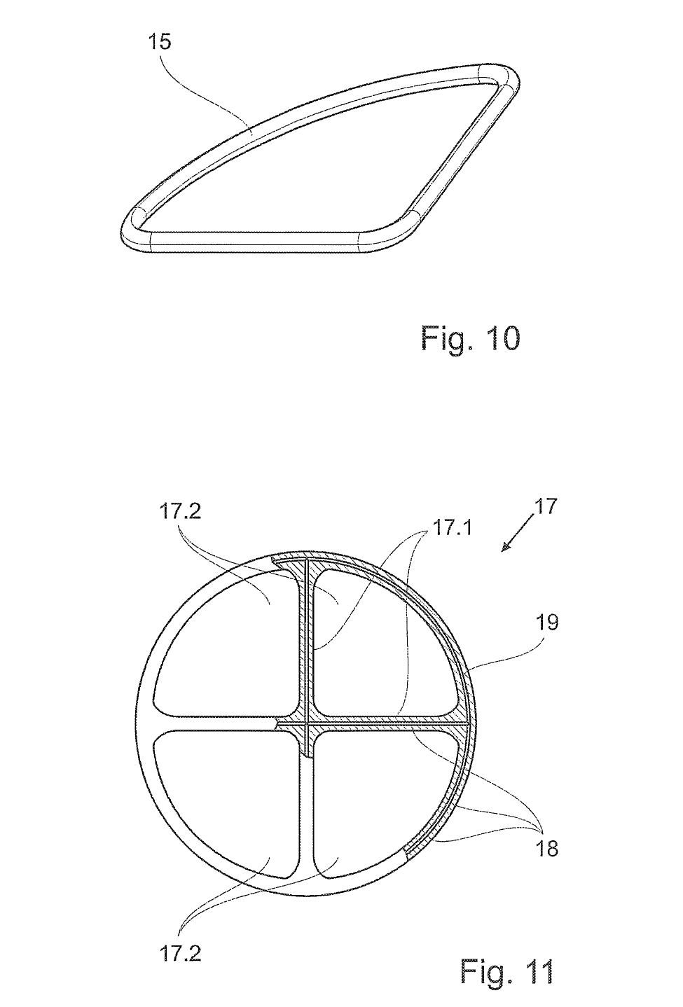

FIG. 10 a first embodiment example of a seal; and

FIG. 11 a second embodiment example of a seal in the form of a seal element with crosspieces.

The following illustrations are shown in simplified, schematic form. Identical reference numbers denote identical technical elements.

FIG. 1 shows cross sections of four filter elements 1, each of which has a cross section corresponding to one fourth of a virtual surface 4 in the shape of a circle (denoted by dashes). The surface 4 is formed by the outwardly directed portions of the circumferences of the filter elements 1. The filter elements 1 are penetrated by longitudinal channels 3 in the longitudinal direction 2 thereof along which the view in FIG. 1 is presented to the observer. The longitudinal channels 3 are delimited from one another and relative to a periphery of the filter elements 1 by channel walls 8 in each instance. Spaces by which the permeate outlets 5 are formed are shown between the filter elements 1. When a medium 7 (see FIG. 3) flows into the longitudinal channels 3, a fraction of the medium 7 (represented by arrows) passes out of the filter element 1 through the channel walls 8 as permeate (represented by arrows) either through the porous material of the filter element 1 until an outer wall of the filter element 1 and through the outer wall or directly through an exterior channel wall 8. In so doing, the permeate passes into the permeate outlets 5. Around the filter elements 1, there is a permeate collection space 20 located between the filter elements 1 and a housing wall 12.3 (see FIG. 9).

When the filter elements 1 are enclosed by a housing wall 12.3 (shown, see also FIG. 9) and if there is a space between the filter elements 1 relative to this housing wall 12.3, a permeate outlet 5 is likewise formed by this space.

FIG. 2 shows a perspective top view of a first embodiment example of a filter element 1 according to the invention. The longitudinal channels 3 which extend in longitudinal direction 2 through the filter element 1 are clearly shown. The cross section of the filter element 1 is one fourth of a surface 4 in the shape of a circle (see also FIG. 1).

A second embodiment example of a filter element 1 according to the invention is shown in FIG. 3. The filter element 1 has slits 9 in its outer wall. FIG. 4 shows a cross section through the filter element 1 at the level of the slits 9. A material zone 6 which is not penetrated by longitudinal channels 3 is provided between the longitudinal channels 3. The slit 9 extends through the outer wall into the material zone 6 without breaching any of the longitudinal channels 3 in so doing. Through the agency of the slit 9, a permeate can be discharged from each of the longitudinal channels 3 in radial direction in a permeate outlet 5 after this permeate has flowed through at most four longitudinal channels 3.

The outer wall of the filter element 1 is sealed in the region of the respective ends of the filter elements 1 without the front openings of the longitudinal channels 3 being closed. This sealing is carried out as a ceramic sealing. In this way, the porous body is sealed at the sides and end, and it is ensured that the medium 7 which streams toward it and which is to be filtered is reliably guided into the interior of the longitudinal channels 3.

In further embodiments of the filter elements 1, the sealing is realized by a glass seal or plastic seal. This front seal extending peripherally around the sides at the ends of the filter elements 1 is typical of all of the filter elements 1.

In further embodiments of the filter elements 1, two, three, or more such material zones 6 can be provided adjoining an outer wall. A slit 9 can be incorporated in each material zone 6. In further embodiments, slits can also be inserted only into some of the material zones 6 provided.

Material zones 6 and slits 9 can be provided adjoining different outer walls in further embodiments.

FIG. 5 shows, as a first embodiment example, a filter element composite 10 in which four filter elements 1 are arranged parallel to one another and at a distance from one another. The cross sections of the filter elements 1 are mutually complementing segments of a virtual rotationally symmetrical and mirror-symmetrical surface 4 in the shape of a circle. The filter elements 1 are joined to one another by individual seals 15 (see also FIG. 10). The spaces between the filter elements 1 also serve in this case as permeate outlets 5 for guiding medium 7 exiting from the filter elements 1 as permeate. The cross section of the filter element composite 10 is the mirror-symmetrical surface 4.

In further embodiments, the filter elements 1 are joined together by one or more seal elements 17 (see also FIG. 11).

In a second embodiment example of a filter element composite 10, FIG. 6 shows six filter elements 1 having in each instance a cross section which forms a sixth of an annulus. A central filter element 1.z is arranged in the center of the filter element composite. The filter elements 1 and the central filter element 1.z are provided with individual seals 15 as were described referring to FIG. 5. The cross section of the filter element composite 10 is the mirror-symmetrical surface 4.

A further embodiment example of a filter element composite 10 is shown in FIG. 7. The filter elements 1 are joined ceramically. To this end, slurry was introduced at different locations between the filter elements 1 and sintered. The sintered slurry forms a sintered disk 21 which encloses the filter elements 1 on all sides along a longitudinal portion. Sintered disks 21 of this type are provided at longitudinal portions at the ends of the filter elements 1 and in the center thereof.

Instead of the above-mentioned sintered disk 21, it is also sufficient when the opposing surfaces of the quarter-circle elements are connected by slurry without causing an additional edge around the four filter elements 1 shown here.

In a further embodiment example, FIG. 8 shows a top view of an input opening 12.1 in which a filter element composite 10 is inserted and fastened by means of a first flange 13 and sealed in cooperation with a seal element 17 (see also FIG. 11).

FIG. 9 schematically shows a filter device 11 having four quarter-circle elements which are sealed relative to one another and relative to the supporting parts of a filter housing 12 by a potting layer 16. The filter device 11 has the filter housing 12 with, in each instance, an input opening 12.1 and an output opening 12.2 in a housing wall 12.3. Filter elements 1 in the form of a filter element composite 10 are arranged between input opening 12.1 and output opening 12.2. The filter element composite 10 is enclosed by the housing wall 12.3.

The filter element composite 10 is fixedly connected at the input opening 12.1 to a first flange 13 by which the filter element composite 10 is screwed to the filter housing 12. After loosening the fastening screw (shown in phantom), the entire filter element composite 10 can be removed through the input opening 12.1. The filter element composite 10 inserted into the filter housing 12 is detachably connected to a second flange 14 at the output opening 12.2 by screw connections (shown in phantom). A permeate collection space 20 is formed between the filter element composite 10 and the housing wall 12.3.

The filter element composite 10 is sealed relative to the input opening 12.1. The seal is formed in this case as a potting layer 16 from a sealing material.

An individual seal 15 such as is described referring to FIG. 5 and which can be used in further embodiments of the filter element composite 10 and filter device 11 is shown by way of example in FIG. 10. The individual seal 15 is a rubber ring with a round material cross section and has a shape which corresponds to one fourth of a circle viewed from above. When four filter elements 1 are provided with an individual seal 15 of this kind and when this individual seal 15 is arranged in the same position in longitudinal direction 2 in all of the filter elements 1, these four individual seals 15 effect a sealing between the filter elements 1 when the filter elements 1 are arranged in a filter element composite 10. At the same time, a space is ensured between the filter elements 1 by the individual seals 15 which contact one another by their outer circumferences.

In its simplest form, the individual seal 15 can have a circular cross section, but in further configurations can also have any other cross sections useful for a good seal such as polygons with or without separately formed sealing lips, with or without grooves which increase the sealing pressure.

An embodiment example of a seal element 17 is shown schematically in FIG. 11. The seal element 17 has a circular outer shape, and the free interior of the seal element 17 is penetrated by two crosspieces 17.1 at right angles to one another and is divided into four apertures 17.2, each of which amounts to one fourth of the interior space. The seal element 17 has a core 19 (shown in partial section) made of a metal insert (or plastic insert) which is enclosed in plastic. Seal lips 18 made of a soft material are provided along the inner sides of the apertures 17.2. The outer circumferential surface of the seal element 17 comprises a soft plastic by which an outer seal lip 18 is formed.

### LIST OF REFERENCE NUMERALS

| | |
|---|---|
| 1 | filter element |
| 1.z | central filter element |
| 2 | longitudinal direction |
| 3 | longitudinal channel |
| 4 | surface |
| 5 | permeate outlet |
| 6 | material zone |
| 7 | medium |
| 8 | channel wall |
| 9 | slit |
| 10 | filter element composite |
| 11 | filter device |
| 12 | filter housing |
| 12.1 | input opening |
| 12.2 | output opening |
| 12.3 | housing wall |
| 13 | first flange |
| 14 | second flange |
| 15 | individual seal |
| 16 | potting layer |
| 17 | seal element |
| 17.1 | crosspiece |
| 17.2 | aperture |
| 18 | seal lip |
| 19 | core |
| 20 | permeate collection space |
| 21 | sintered disk |

1.-13. (canceled)

14. A filter element, wherein the filter element is made of a material which is permeable to permeate, comprises a plurality of longitudinal channels, and has a cross section that is a segment of a virtual rotationally symmetrical or mirror-symmetrical surface.

15. The filter element of claim 14, wherein the filter element comprises, at least along a longitudinal portion thereof, material zones between the longitudinal channels, which material zones extend from an outer wall of the filter element some distance into the filter element, are not penetrated by longitudinal channels, and comprise a slit, no longitudinal channels being breached by the slit.

16. A filter element composite, wherein the filter element composite comprises a plurality of filter elements and wherein
cross sections of the plurality of filter elements are mutually complementing segments of a rotationally symmetrical surface or a mirror-symmetrical surface,
the filter elements are joined to one another, a space being present between the filter elements as permeate outlets for conducting medium exiting from the filter elements as permeate, and
a cross section of the filter element composite is the rotationally symmetrical surface or the mirror-symmetrical surface.

17. The filter element composite of claim 16, wherein the filter elements are joined ceramically or by a potting compound.

18. The filter element composite of claim 16, wherein the filter element composite further comprises a central filter element that is surrounded by the plurality of filter elements, a cross section of the central filter element deviating from a shape of cross sections of the surrounding filter elements.

19. A filter device for cleaning or separating a medium, wherein the filter device comprises filter elements according to claim 14, and wherein
the filter device further comprises a filter housing having an input opening for the medium to flow into the filter housing and at least one output opening for the medium to flow out,
the filter device comprises at least two filter elements comprising a plurality of longitudinal channels, the filter elements being arranged so as to extend from the input opening into the filter housing, and an end side of the filter elements staying open in each instance for the medium to flow into the longitudinal channels of the filter elements,
the filter elements are sealed by a seal at least at the input opening, and the filter elements are sealed relative to one another and relative to the filter housing and are kept at a distance from one another by the seal, and
permeate outlets are formed by spaces between the filter elements and relative to the filter housing for conducting the medium exiting from the filter elements as permeate in direction of the at least one output opening.

20. The filter device of claim 19, wherein cross sections of the filter elements are mutually complementing segments of a rotationally symmetrical surface or a mirror-symmetrical surface.

21. A filter device for cleaning or separating a medium, wherein the filter device comprises a filter element composite according to claim 16, and wherein
the filter device further comprises a filter housing comprising an input opening for the medium to flow into the filter housing and at least one output opening for the medium to flow out,
the filter element composite is sealed by a seal at least at the input opening and the filter elements of the filter element composite are sealed relative to one another and relative to the filter housing and are kept at a distance from one another by the seal, and
permeate outlets are formed by spaces between the filter elements and relative to the filter housing for conducting the medium exiting from the filter elements as permeate in direction of the at least one output opening.

22. The filter device of claim 19, wherein the seal is a potting layer made of a sealing material.

23. The filter device of claim 21, wherein the seal is a potting layer made of a sealing material.

24. A seal for the filter device of claim 19, wherein the seal is an individual seal comprising, in uninstalled condition, a shape of a cross section of that segment for which the individual seal is provided.

25. The seal of claim 24, wherein the seal is made of mixtures or a composite of a plurality of plastics or of a composite material.

26. The seal of claim 25, wherein the seal comprises metal supporting elements.

27. The filter device of claim 19, wherein the seal is an individual seal comprising, in uninstalled condition, a shape of a cross section of that segment for which the individual seal is provided.

28. The filter device of claim 21, wherein the seal is an individual seal comprising, in uninstalled condition, a shape of a cross section of that segment for which the individual seal is provided.

29. A seal for the filter device of claim 19, wherein the seal is a seal element which is a disk-shaped element comprising crosspieces and apertures, where the shape and size of the apertures allow filter elements to be inserted into the apertures in a frictionally engaging manner.

30. The seal of claim 29, wherein the seal is made of mixtures or a composite of a plurality of plastics or of a composite material.

31. The seal of claim 30, wherein the seal comprises metal supporting elements.

32. The filter device of claim 19, wherein the seal is a seal element which is a disk-shaped element comprising crosspieces and apertures, where the shape and size of the apertures allow filter elements to be inserted into the apertures in a frictionally engaging manner.

33. The filter device of claim 21, wherein the seal is a seal element which is a disk-shaped element comprising crosspieces and apertures, where the shape and size of the apertures allow filter elements to be inserted into the apertures in a frictionally engaging manner.
